(19) United States
(12) Patent Application Publication
(10) Pub. No.: US 2011/0121786 A1
(43) Pub. Date: May 26, 2011

(54) METHOD OF DETECTING CONDITION OF SECONDARY BATTERY

(75) Inventors: Sho Tsuruta, Kobe-shi (JP); Katsunori Yanagida, Kobe-shi (JP)

(73) Assignee: SANYO ELECTRIC CO., LTD., Osaka (JP)

(21) Appl. No.: 12/953,970

(22) Filed: Nov. 24, 2010

(30) Foreign Application Priority Data
Nov. 25, 2009 (JP) 2009-266934

(51) Int. Cl. H02J 7/00; H02J 7/04

(52) U.S. Cl. 320/132; 320/162

(57) ABSTRACT

A method of detecting a condition of a secondary battery is provided. The method includes the steps of: measuring an entropy change at a predetermined state of charge of the secondary battery; charging the secondary battery after the step of measuring an entropy change; repeating the steps of measuring an entropy change and charging the secondary battery; and detecting a deterioration condition of the secondary battery based on the slope of a measured entropy change curve with respect to state of charge.

### BACKGROUND OF THE INVENTION

1. Field of the Invention

The present invention relates to methods of detecting a condition of a secondary battery.

2. Description of Related Art

Currently, various batteries are used as the power sources of mobile devices. However, there are cases in which the battery is exhausted and the mobile device becomes unusable faster than was expected because the deterioration condition of the battery cannot be detected accurately. For this reason, there is a need for a method of detecting the condition of a battery more accurately by a nondestructive method.

Published Japanese Translation of PCT Application No. 2009-506483 proposes a method for evaluating an electrode material using open circuit voltages (OCV) and changes in entropy (ΔS) determined by an experiment concerning the lithium insertion of LiMn₂O₄. However, this method cannot detect the deterioration conditions of batteries accurately.

### BRIEF SUMMARY OF THE INVENTION

It is an object of the present invention to provide a method of detecting a deterioration condition of a battery more accurately by a nondestructive method.

The present invention provides a method of detecting a condition of a secondary battery, comprising the steps of: measuring an entropy change at a predetermined state of charge of the secondary battery; charging the secondary battery after the step of measuring an entropy change; repeating the steps of measuring an entropy change and charging the secondary battery; and detecting a condition of the secondary battery based on the slope of a measured entropy change curve with respect to state of charge.

According to the present invention, the slope of the measured entropy change curve with respect to state of charge changes greatly corresponding to the deterioration condition of the battery, and therefore, based on the change, the deterioration condition of the battery can be detected more accurately using a nondestructive method.

### BRIEF DESCRIPTION OF THE DRAWINGS

FIG. 1 illustrates a laminate cell used in Examples 1 to 3 and Comparative Examples 1 to 3;

FIG. 2 illustrates a test cell used in Examples 1 to 3 and Comparative Examples 1 to 3;

FIG. 3 is a graph illustrating open circuit voltages at respective temperatures, measured in Example 1;

FIG. 4 is a graph illustrating temperature dependence of the open circuit voltages measured in Example 1;

FIG. 5 is a graph illustrating the entropy change curve and the OCV curve versus lithium amount x, obtained in Example 1;

FIG. 6 is a graph illustrating the entropy change curve and the OCV curve versus lithium amount x, obtained in Example 2;

FIG. 7 is a graph illustrating the entropy change curve and the OCV curve versus lithium amount x, obtained in Example 3;

FIG. 8 is a graph illustrating the entropy change curve and the OCV curve versus lithium amount x, obtained in Comparative Example 1;

FIG. 9 is a graph illustrating the entropy change curve and the OCV curve versus lithium amount x, obtained in Comparative Example 2;

FIG. 10 is a graph illustrating the entropy change curve and the OCV curve versus lithium amount x, obtained in Comparative Example 3;

FIG. 11 shows the X-ray diffraction pattern of a positive electrode active material in Example 3 when the lithium amount x=0.964;

FIG. 12 shows the X-ray diffraction pattern of the positive electrode active material in Example 3 when the lithium amount x=0.882;

FIG. 13 is a graph illustrating the slope of the entropy change curve with respect to lithium amount x, obtained in Example 1;

FIG. 14 is a graph illustrating the slope of the entropy change curve with respect to lithium amount x, obtained in Example 2;

FIG. 15 is a graph illustrating the slope of the entropy change curve with respect to lithium amount x, obtained in Example 3;

FIG. 16 is a graph illustrating the slope of the entropy change curve with respect to lithium amount x, obtained in Comparative Example 1;

FIG. 17 is a graph illustrating the slope of the entropy change curve with respect to lithium amount x, obtained in Comparative Example 2;

FIG. 18 is a graph illustrating the slope of the entropy change curve with respect to lithium amount x, obtained in Comparative Example 3; and

FIG. 19 is a graph illustrating the relationship between the capacity retention ratio and the slopes of the entropy change curves of Examples 1 to 3 and Comparative Examples 1 to 3.

### DETAILED DESCRIPTION OF THE INVENTION

The present invention provides a method of detecting a condition of a secondary battery, comprising the steps of: measuring an entropy change at a predetermined state of charge of the secondary battery; charging the secondary battery after the step of measuring an entropy change; repeating the steps of measuring an entropy change and charging the secondary battery; and detecting a condition of the secondary battery based on the slope of a measured entropy change curve with respect to state of charge.

According to the present invention, the slope of the measured entropy change curve with respect to state of charge changes greatly corresponding to the deterioration condition of the battery, and therefore, based on the change, the deterioration condition of the battery can be detected more accurately using a nondestructive method.

The entropy change can be obtained by measuring open circuit voltages at a plurality of different temperatures. In more detail, the entropy change can be obtained by assigning the values of the measured temperature and the measured open circuit voltage in Equation (1).

$$Δ S = F \frac{\partial Δ E}{\partial T} \qquad Eq . ( 1 )$$

(ΔS: entropy change, F: Faraday constant, ΔE: open circuit voltage, T: temperature)

The slope of the entropy change changes greatly at the state of charge in which two crystal structure phases coexist in the positive electrode active material of the lithium secondary battery. Therefore, the detection accuracy can be enhanced by conducting the above-described condition detecting method at the just-mentioned state of charge.

In addition, detection accuracy can be enhanced by conducting the detection of the deterioration condition by the above-described condition detecting method after discharging the lithium secondary battery until the positive electrode potential reaches 2.75 V or lower versus a lithium standard electrode potential.

Moreover, the slope of the measured entropy change curve with respect to the predetermined state of charge is obtained when the positive electrode potential of the lithium secondary battery at the state of charge is within the range of from 3.905 V to 3.913 V verses a lithium standard electrode potential. As a result, the detection accuracy of the deterioration condition can be enhanced.

In the case where the state of charge is represented by a lithium amount x of LiₓMO₂, where M is at least one element selected from the group consisting of Ni, Co, and Mn, and 0≦x≦1, the secondary battery may be determined to be in a deterioration condition when the slope of the measured entropy change curve with respect to the lithium amount x is −160 or less.

According to the present invention, the slope of the measured entropy change curve with respect to state of charge changes greatly corresponding to the deterioration condition of the battery, and therefore, based on the change, the deterioration condition of the battery can be detected more accurately using a nondestructive method.

### EXAMPLES

Hereinbelow, the present invention is described in further detail based on specific examples thereof. It should be construed, however, that the present invention is not limited to the following examples.

### Example 1

### Preparation of Laminate Cell

Lithium cobalt oxide as a positive electrode active material, carbon as a conductive agent, and polyvinylidene fluoride as a binder agent were mixed together in amounts of 95 parts by weight, 2.5 parts by weight, and 2.5 parts by weight, respectively, with respect to the total weight of the positive electrode active material, the conductive agent, and the binder agent. N-methyl-2-pyrrolidone was added to this mixture to form a slurry. The resultant slurry was applied onto both sides of a current collector made of an aluminum foil, and then dried. The resultant electrode was calendered and cut out into a plate shape, and a tab 1 was attached thereto. Thus, a positive electrode 2 was prepared.

Graphite as a negative electrode active material, carboxymethylcellulose as a thickening agent, and styrene-butadiene rubber as a binder agent were mixed together in amounts of 98 parts by weight, 1 part by weight, and 1 part by weight, respectively, with respect to the total weight of the negative electrode active material, the thickening agent, and the binder agent. Water was added to this mixture to form a slurry. The resultant slurry was applied onto both sides of a current collector made of an aluminum foil, and then dried. The resultant electrode was calendered and cut out into a plate shape, and a tab 1 was attached thereto. Thus, a negative electrode 3 was prepared.

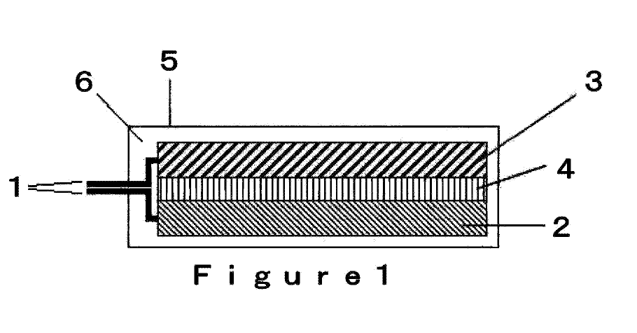

The positive electrode 2 and the negative electrode 3 prepared in the just-described manner were opposed to each other with a polyethylene separator 4 interposed therebetween. These were wound in a spiral state and pressed to prepare a flat electrode assembly. This flat electrode assembly was inserted into a battery case made of an aluminum laminate film 5, and a non-aqueous electrolyte 6 was filled therein. Thereafter, the battery case was sealed. Thereby, a laminate cell (FIG. 1) having a design capacity of 700 mAh was prepared.

The non-aqueous electrolyte 6 was prepared as follows. Lithium hexafluorophosphate as an electrolyte salt was added at a concentration of 1 mol/L to a non-aqueous solvent of 30:70 volume ratio mixture of ethylene carbonate and diethyl carbonate.

The prepared laminate cell was charged at a constant current of 700 mA until the voltage reached 4.4 V, and further charged at a constant voltage until the current value reached 35 mA. Thereafter, the cell was discharged at a constant current of 700 mA until the voltage reached 2.75 V, and it was found that the discharge capacity of the cell was 700 mAh.

### Deterioration Test

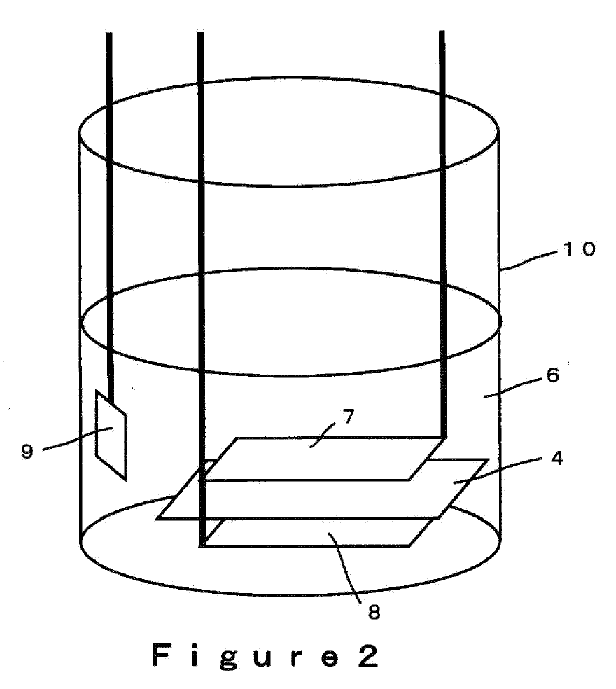

The prepared laminate cell was charged at a constant current of 700 mA until the voltage reached 4.4 V, and further charged at a constant voltage until the current value reached 35 mA. Thereafter, the cell was discharged at a constant current of 700 mA until the voltage reached 2.75 V. This charge-discharge cycle was repeated to carry out a 100-cycle test. Thereafter, the laminate cell was disassembled, and the positive electrode was cut out into a plate shape with dimensions of 5.7 cm×2.5 cm. The positive electrode plate was then washed with diethyl carbonate and dried, and a tab was attached thereto, whereby a working electrode 7 was prepared. This working electrode 7, a counter electrode 8 and a reference electrode 9, each of which made of metallic lithium with dimensions of 8.0 cm×4.0 cm, the non-aqueous electrolyte solution 6, and the separator 4, were used to prepare a test cell 10 (FIG. 2).

### Pre-Measurement Charge-Discharge Operation

The prepared test cell was charged with a constant current at a current density of 0.75 mA/cm² until the potential of the working electrode reached 4.3 V versus the reference electrode, and thereafter discharged with a constant current at a current density of 0.75 mA/cm² until the potential of the working electrode reached 2.75 V versus the reference electrode. This charge-discharge test was repeated two times. Thereafter, the test cell was charged with a constant current at a current density of 15 mA/g until the potential of the working electrode reached 4.3 V versus the reference electrode, and thereafter discharged with a constant current at a current density of 15 mA/g until the potential of the working electrode reached 2.75 V versus the reference electrode, to calculate the discharge capacity Q1. The just-mentioned current density was obtained by dividing the current value by the total weight of the active material, the conductive agent, and the binder agent. Based on the discharge capacity Q1 thus obtained, the current densities in the subsequent measurements were calculated.

### Method of Calculating Entropy

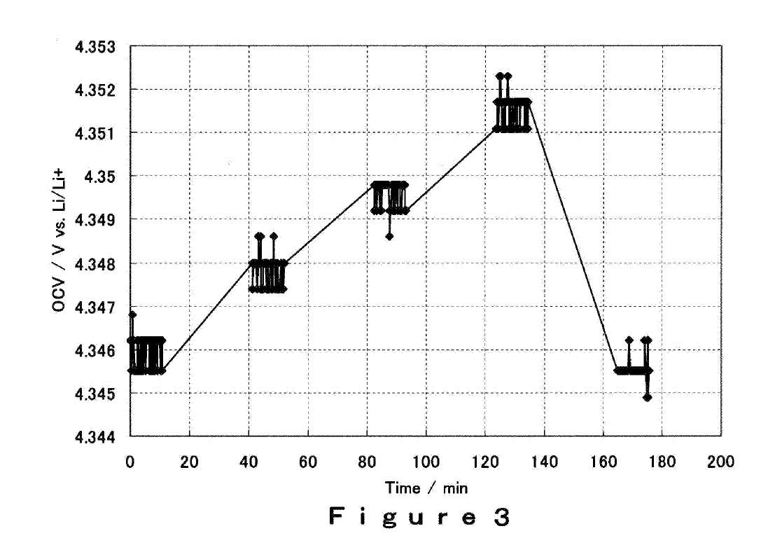

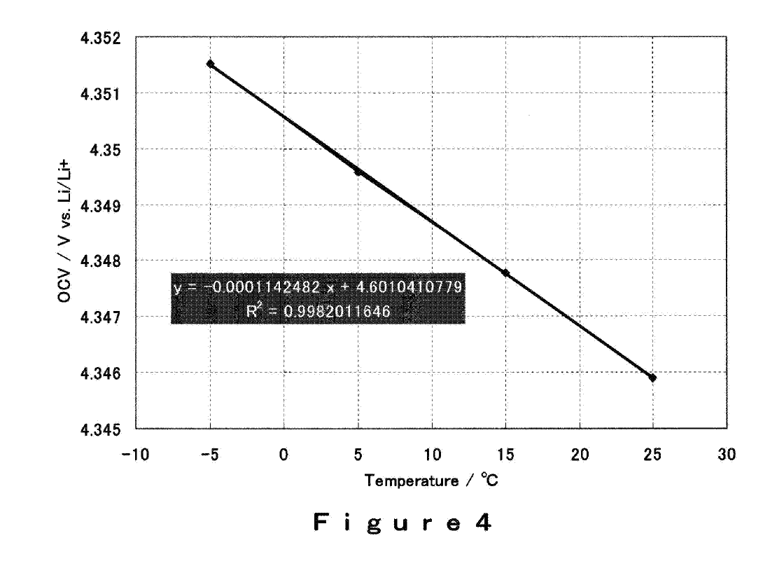

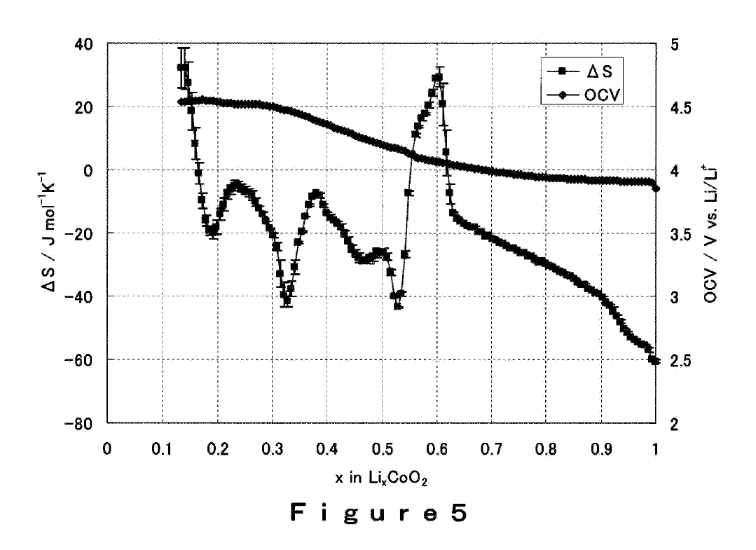

Using the test cell subjected to the pre-measurement charge-discharge operation, the open circuit voltage was measured for 10 minutes at each of the temperatures of 25° C., 15° C., 5° C., and −5° C. (FIG. 3), and from the mean values, the slope of linear line was obtained by the least-squares method (FIG. 4), to calculate the entropy change from Equation (1). Thereafter, the cell was charged by applying a current with a current density of 0.05 It for 10 minutes, and thereafter set aside for at least 120 minutes. These steps were repeated, and the entropy changes with respect to the lithium amount x in the lithium cobalt oxide of the positive electrode, represented by the chemical formula LiₓCoO₂ (0≦x≦1), were plotted (FIG. 5).

### Example 2

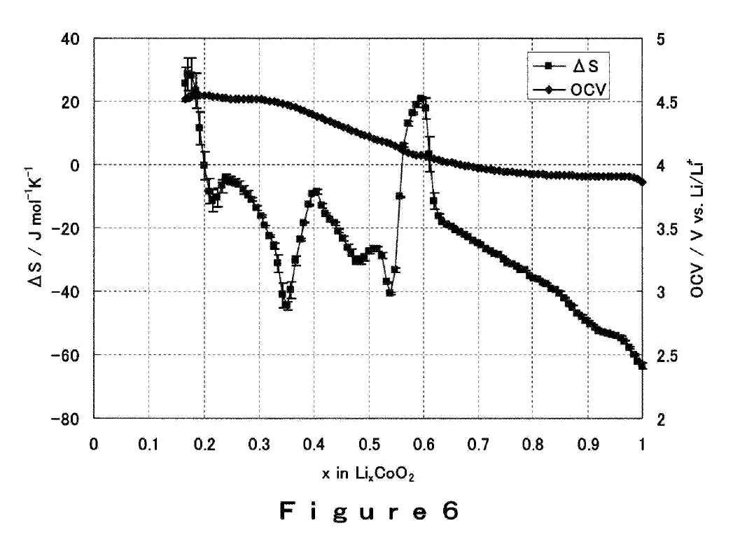

The entropy changes with respect to the lithium amount x were plotted (FIG. 6) in the same manner as described in Example 1, except that the following deterioration test was conducted in place of the deterioration test performed in Example 1.

### Deterioration Test

A laminate cell fabricated in the same manner as described in Example 1 was charged at a constant current of 700 mA at room temperature until the voltage reached 4.4 V, and further charged at a constant voltage until the current value reached 35 mA. Thereafter, the cell was stored in a thermostatic chamber at 60° C. for 20 days.

### Example 3

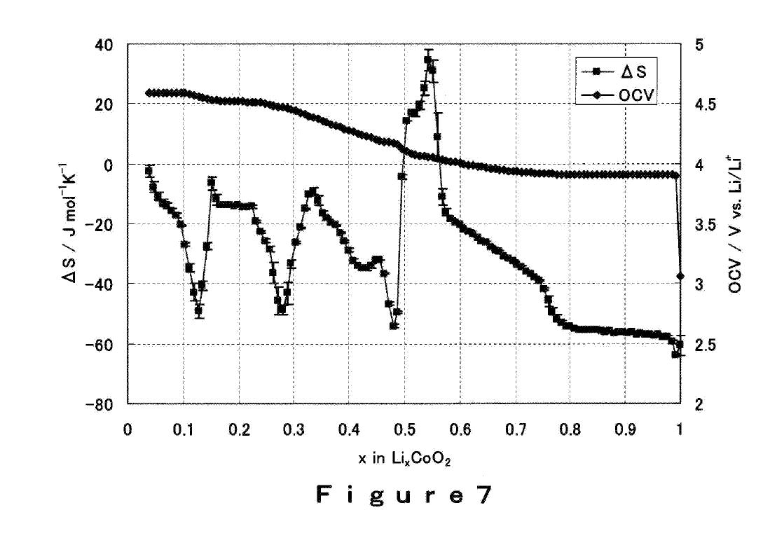

The entropy changes with respect to the lithium amount x were plotted (FIG. 7) in the same manner as described in Example 1, except that the deterioration test performed in Example 1 was not conducted.

### Comparative Example 1

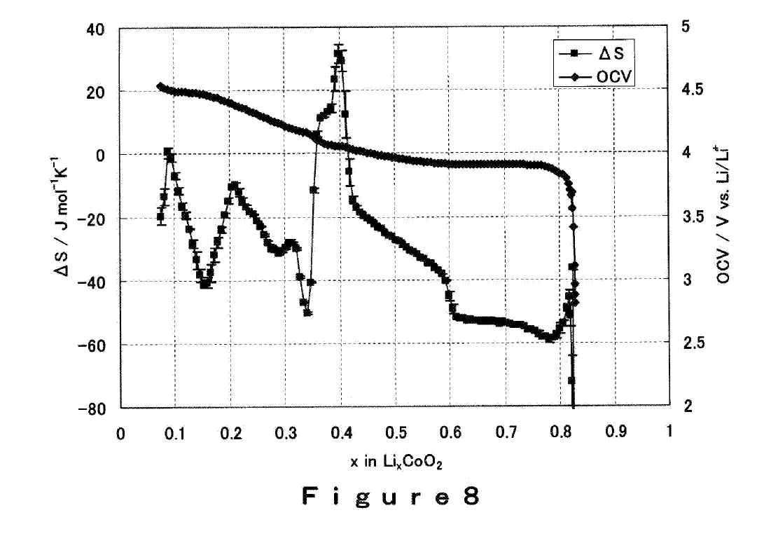

The entropy changes with respect to the lithium amount x were plotted (FIG. 8) in the same manner as described in Example 1, except that the following pre-measurement charge-discharge operation and the entropy calculating method were conducted in place of the pre-measurement charge-discharge operation and the entropy calculating method of Example 1.

### Pre-Measurement Charge-Discharge Operation

The pre-measurement charge-discharge operation as in Example 1 was carried out, and thereafter, the cell was charged at a current density of 0.05 It until the potential of the working electrode reached 5.0 V versus the reference electrode.

### Method of Calculating Entropy

The entropy changes with respect to the lithium amount x were plotted (FIG. 1) in the same manner as the entropy calculating method described in Example 1, except that, in place of charging the cell by applying a current at a current density of 0.05 It for 10 minutes, the cell was discharged under the same conditions.

### Comparative Example 2

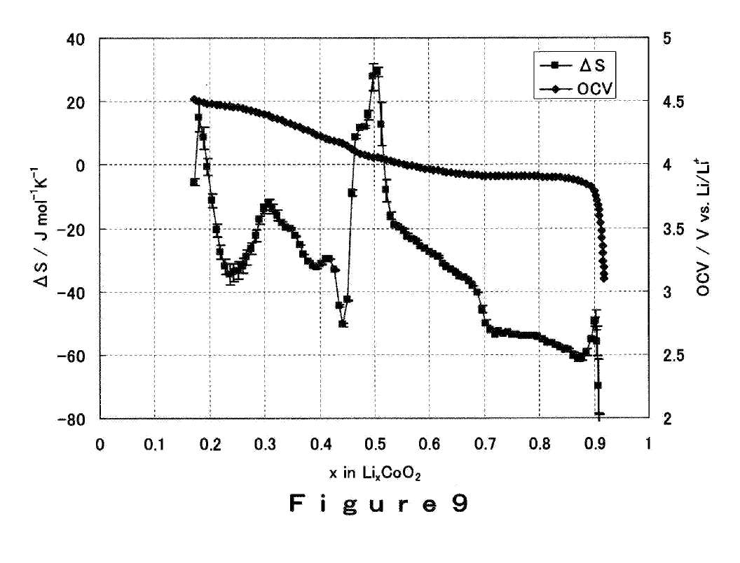

The entropy changes with respect to the lithium amount x were plotted (FIG. 9) in the same manner as described in Example 1, except that the deterioration test as described in Example 2 above was conducted in place of the deterioration test performed in Comparative Example 1.

### Comparative Example 3

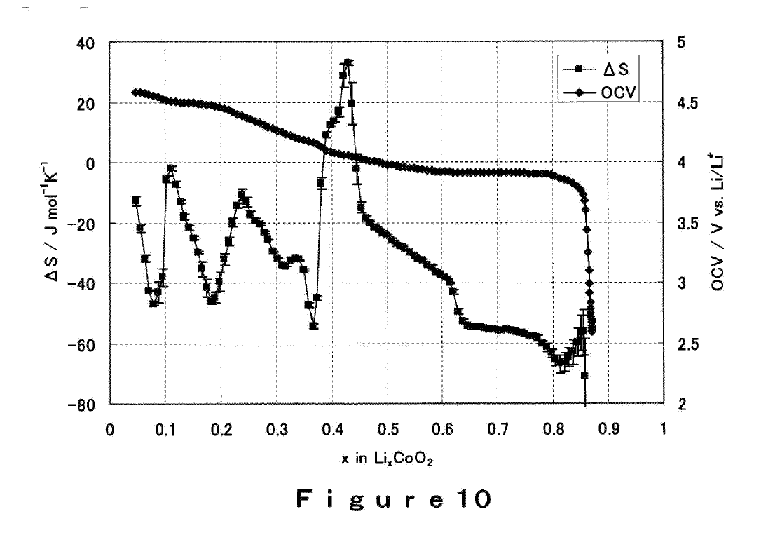

The entropy changes with respect to the lithium amount x were plotted (FIG. 10) in the same manner as described in Comparative Example 1, except that the deterioration test performed in Comparative Example 1 was not conducted.

Table 1 below shows the capacity retention ratios of Examples 1 and 2 relative to Example 3. The capacity of each of the cells was determined in the pre-measurement charge-discharge operation.

TABLE 1

| | Ex. 1 | Ex. 2 | Ex. 3 |
|---|---|---|---|
| Capacity retention ratio | 68.5 | 78.5 | — |
| relative to Ex. 3 | | | |
| (%) | | | |

Table 2 below shows the capacity retention ratios of Comparative Examples 1 and 2 relative to Comparative Example 3. The capacity of each of the cells was determined in the pre-measurement charge-discharge operation.

TABLE 2

| | Comp. Ex. 1 | Comp. Ex. 2 | Comp. Ex. 3 |
|---|---|---|---|
| Capacity retention ratio | 68.5 | 78.5 | — |
| relative to Comp. Ex. 3 | | | |
| (%) | | | |

It is believed that the three peaks observed in each of FIGS. 5 to 7, which correspond to Examples 1 to 3, respectively, correspond to the phase transitions of the positive electrode. The long plateau of the entropy change curve immediately after starting the charging that was observed in Example 3 was not observed in Examples 1 and 2.

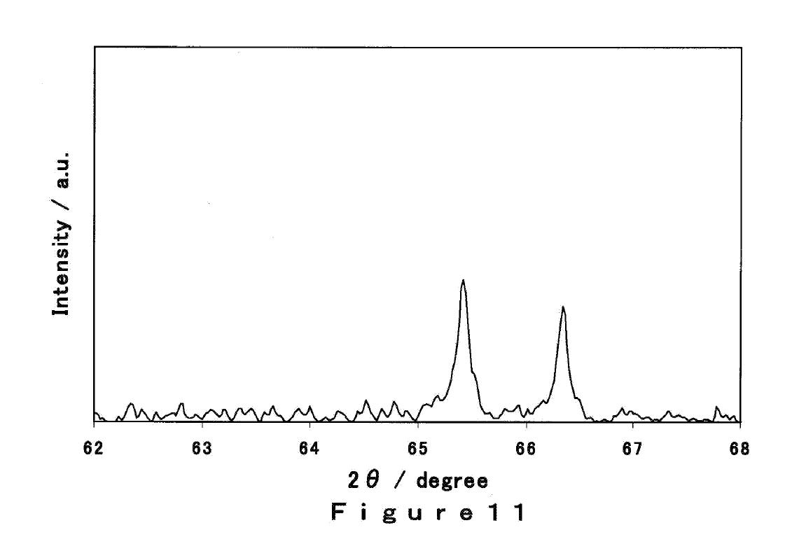

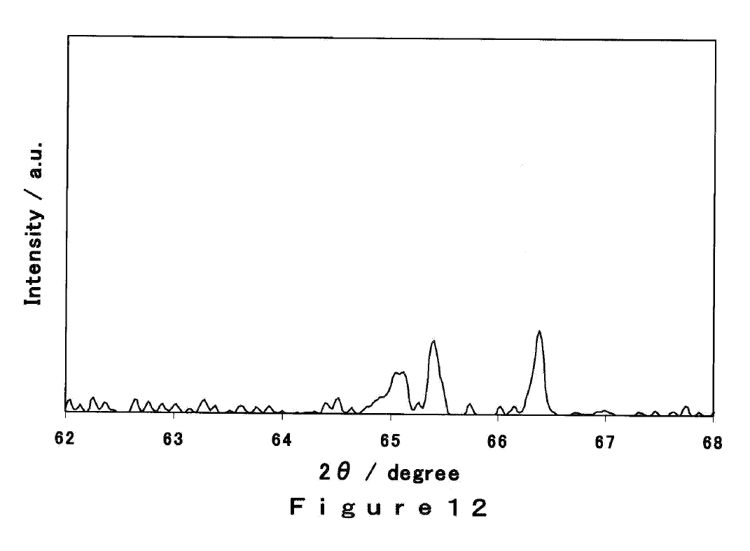

FIGS. 11 and 12 show the X-ray diffraction patterns of the positive electrode active material of Example 3 when the lithium amounts x are 0.964 and 0.882, respectively. In FIG. 11, only the O3I structure is observed, but in FIG. 12, the O3II structure (in the vicinity of 2θ=65°) is observed in addition to the O3I structure. Therefore, it is believed that the plateau observed in Example 3 indicates the two-phase coexisting region of the O3I+O3II structures.

As in Examples 1 to 3, three peaks are similarly observed in each of FIGS. 8 to 10, which correspond to Comparative Examples 1 to 3. However, no difference was observed among FIGS. 8 to 10 in the appearance of the plateau of the entropy change curve immediately after starting the charging.

Thus, FIGS. 5 to 7 show that the deterioration conditions of the batteries are detected more accurately by the Examples, in which the step of measuring an entropy change and the step of thereafter charging the battery are repeated in the entropy calculating method. On the other hand, FIGS. 8 to 10 show that the deterioration conditions of the batteries cannot be detected accurately by the Comparative Examples, in which the step of measuring an entropy change and the step of thereafter discharging the battery are repeated in the entropy calculating method.

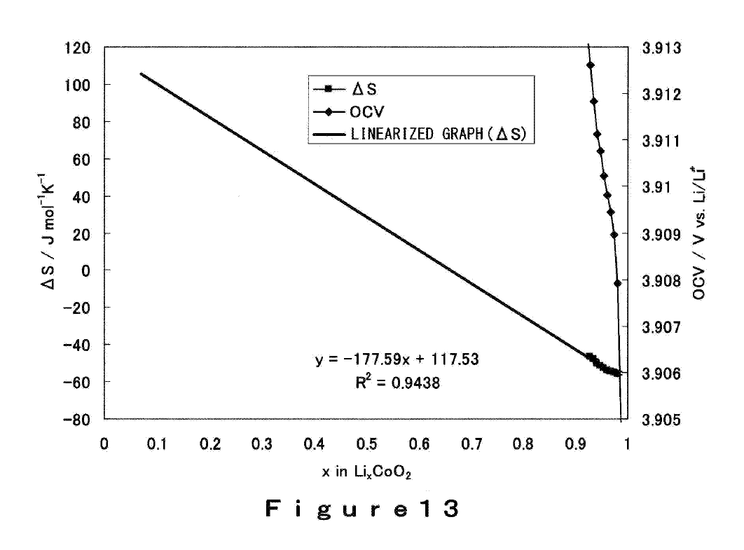

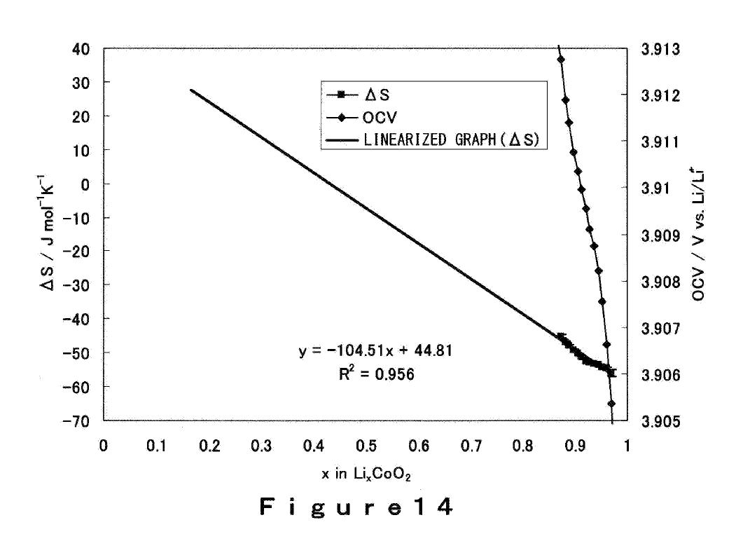

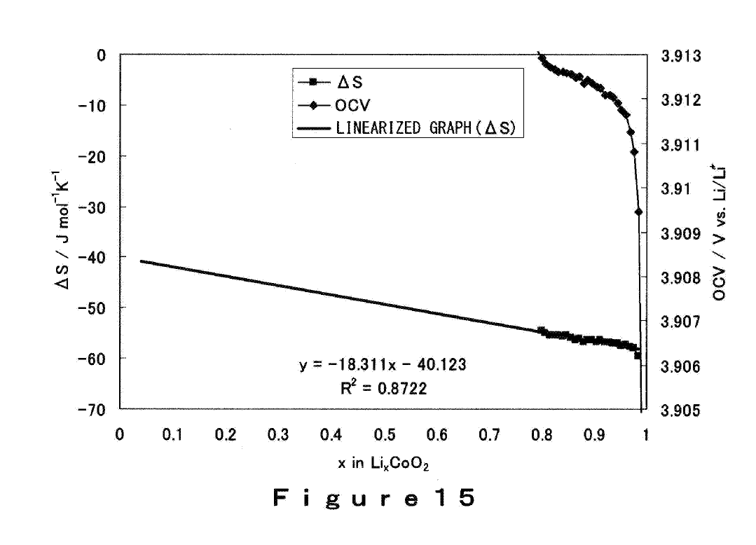

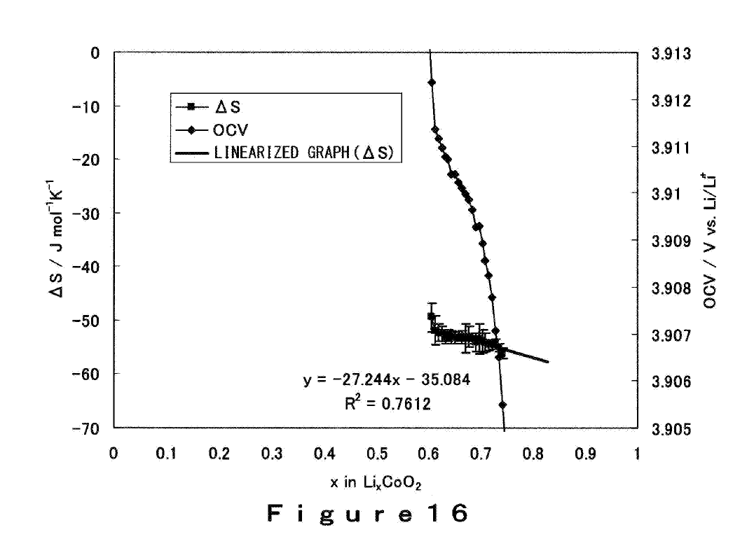

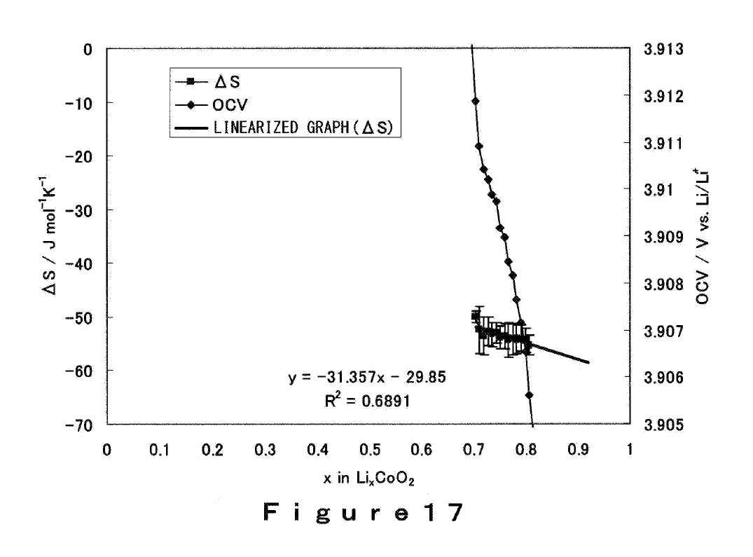

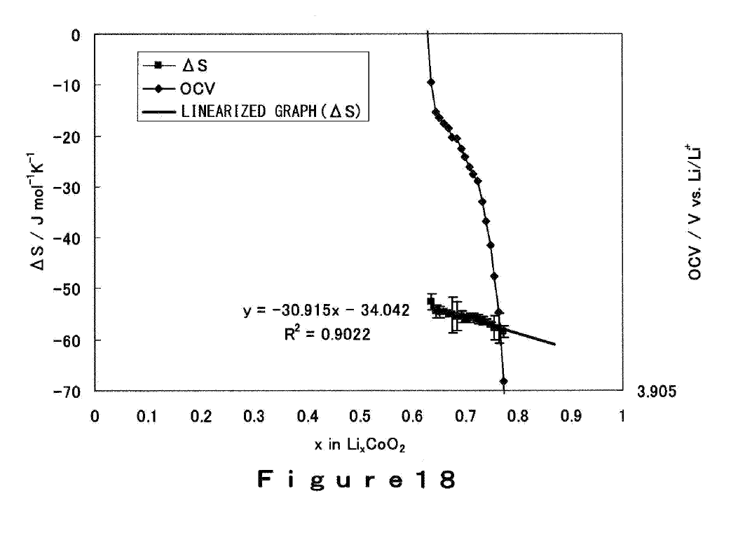

Subsequently, by the least-squares method, the slopes of the entropy change curves of Examples 1 to 3 were obtained when the potential of the working electrode versus a reference electrode was from 3.905 V to 3.913 V, the results of which are shown in FIGS. 13 to 15, respectively. Likewise, the slopes of the entropy change curves of Comparative Examples 1 to 3 are shown in FIGS. 16 to 18, respectively. While the slope of the entropy change curve was −18.311 in Example 3, the slopes in Examples 1 and 2 were −177.59 and −104.51, respectively, indicating great changes. On the other hand, the slope of the entropy change curve was −30.915 in Comparative Example 3, and the slopes in Comparative Examples 1 and 2 were −27.244 and −31.357, respectively, indicating little changes.

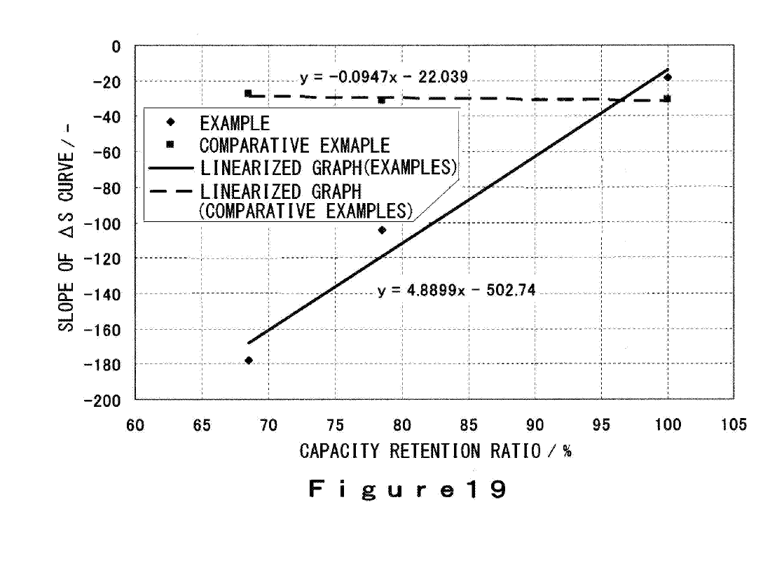

The relationship between the slopes of the entropy change curves obtained and the capacity retention ratios is shown in FIG. 19. The slopes of the linear lines were obtained for Examples 1 to 3 and Comparative Examples 1 to 3 by the least-squares method. It was found that, while the absolute value of the slope for Comparative Examples 1 to 3 was 0.1 or less, the slope for Examples 1 to 3 was about 4.9, about 50 times greater. If the slope of the linear line is great as in Examples 1 to 3, it is possible to quantitatively detect a precise deterioration condition of the secondary battery accurately. Moreover, this method enables to detect the deterioration condition of the secondary battery by performing the entropy measurement in a portion of the state-of-charge region, so this method is simpler than the method in which the capacity retention ratio is obtained by conducting a charge-discharge test.

In the case where a battery is determined to be in a deteriorated condition when the capacity retention ratio falls to 70% or less, it can be determined from Example 3 that the secondary battery is in a deteriorated condition when the slope of the entropy change curve with the positive electrode potential being from 3.905 V to 3.913 V is −160 or less.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A method of detecting a condition of a secondary battery, comprising the steps of:
measuring an entropy change at a predetermined state of charge of the secondary battery;
charging the secondary battery after the step of measuring an entropy change;
repeating the steps of measuring an entropy change and charging the secondary battery; and
detecting a condition of the secondary battery based on the slope of a measured entropy change curve with respect to state of charge.

2. The method according to claim 1, wherein the entropy changes are obtained by measuring open circuit voltages at a plurality of different temperatures.

3. The method according to claim 2, wherein the temperatures are within the range of from −5° C. to 25° C.

4. The method according to claim 1, wherein the secondary battery is a lithium secondary battery.

5. The method according to claim 2, wherein the secondary battery is a lithium secondary battery.

6. The method according to claim 3, wherein the secondary battery is a lithium secondary battery.

7. The method according to claim 4, wherein the lithium secondary battery has a positive electrode active material in which two crystal structure phases coexist at the predetermined state of charge.

8. The method according to claim 5, wherein the lithium secondary battery has a positive electrode active material in which two crystal structure phases coexist at the predetermined state of charge.

9. The method according to claim 6, wherein the lithium secondary battery has a positive electrode active material in which two crystal structure phases coexist at the predetermined state of charge.

10. The method according to claim 4, further comprising, prior to the steps of measuring entropy changes and charging the secondary battery, discharging the secondary battery until the positive electrode potential of the lithium secondary battery reaches 2.75 V or lower versus a lithium standard electrode potential.

11. The method according to claim 5, further comprising, prior to the steps of measuring entropy changes and charging the secondary battery, discharging the secondary battery until the positive electrode potential of the lithium secondary battery reaches 2.75 V or lower versus a lithium standard electrode potential.

12. The method according to claim 6, further comprising, prior to the steps of measuring entropy changes and charging the secondary battery, discharging the secondary battery until the positive electrode potential of the lithium secondary battery reaches 2.75 V or lower versus a lithium standard electrode potential.

13. The method according to claim 7, further comprising, prior to the steps of measuring entropy changes and charging the secondary battery, discharging the secondary battery until the positive electrode potential of the lithium secondary battery reaches 2.75 V or lower versus a lithium standard electrode potential.

14. The method according to claim 8, further comprising, prior to the steps of measuring entropy changes and charging the secondary battery, discharging the secondary battery until the positive electrode potential of the lithium secondary battery reaches 2.75 V or lower versus a lithium standard electrode potential.

15. The method according to claim 9, further comprising, prior to the steps of measuring entropy changes and charging the secondary battery, discharging the secondary battery until the positive electrode potential of the lithium secondary battery reaches 2.75 V or lower versus a lithium standard electrode potential.

16. The method according to claim 6, wherein the lithium secondary battery has a positive electrode active material containing a lithium cobalt oxide.

17. The method according to claim 6, wherein the positive electrode potential of the lithium secondary battery at the predetermined state of charge is within the range of from 3.905 V to 3.913 V verses a lithium standard electrode potential.

18. The method according to claim 16, wherein the positive electrode potential of the lithium secondary battery at the predetermined state of charge is within the range of from 3.905 V to 3.913 V verses a lithium standard electrode potential.

19. The method according to claim 18, wherein the state of charge is represented by a lithium amount x of LiₓMO₂, where M is at least one element selected from the group consisting of Ni, Co, and Mn, and 0≦x≦1.

20. The method according to claim 19, wherein the secondary battery is determined to be in a deteriorated condition when the slope of the measured entropy change curve with respect to the lithium amount x is −160 or less.
